(19) United States
(12) Patent Application Publication
(10) Pub. No.: US 2024/0177164 A1
(43) Pub. Date: May 30, 2024

(54) METHODS AND SYSTEMS FOR PREDICTING FRAUDULENT TRANSACTIONS BASED ON ACQUIRER-LEVEL CHARACTERISTICS MODELING

(71) Applicant: Mastercard International Incorporated, Purchase, NY (US)

(72) Inventors: Shraddha Pandey, Pune (IN); Anand Vir Singh Chauhan, Gwalior (IN); Kushagra Agarwal, Jhansi (IN); Tarun Somavarapu, Hyderabad (IN); Shantanu Verma, Ghaziabad (IN); Maneet Singh, New Delhi (IN)

(73) Assignee: Mastercard International Incorporated, Purchase, NY (US)

(21) Appl. No.: 18/168,602

(22) Filed: Feb. 14, 2023

(30) Foreign Application Priority Data
Nov. 30, 2022 (IN) 202241069137

(51) Int. Cl. G06Q 20/40

(52) U.S. Cl. CPC G06Q 20/4016; G06Q 20/407

(57) ABSTRACT

Embodiments provide methods and systems for training a transaction monitoring model based on a multi-component event-aware loss function. The method performed by a server system includes accessing historical transaction data of payment transactions associated with an acquirer server. Method includes determining acquirer features associated with the acquirer server and transaction features associated with an individual payment transaction based on the historical transaction data. Method includes generating, via an embedding layer, a latent representation corresponding to the individual payment transaction. Method includes training a fraud classifier and an acquirer classifier based on the latent representation and the multi-component event-aware loss function. Method includes computing the multi-component event-aware loss function based on execution of the fraud classifier and the acquirer classifier. Moreover, method includes updating network parameters of the fraud classifier, the acquirer classifier, and the embedding layer based on the multi-component event-aware loss function.

### CROSS REFERENCE TO RELATED APPLICATION

This application claims priority of Indian Application Serial No. 202241069137, filed Nov. 30, 2022, the entirety of which is hereby incorporated by reference herein.

### TECHNICAL FIELD

The present disclosure relates to artificial intelligence processing systems and, more particularly to, electronic methods and complex processing systems for the prediction of fraudulent payment transactions based on characteristics modeling of acquirers.

### BACKGROUND

Nowadays, payment transaction fraud is a major concern. Fraud payment transactions that are not blocked in real-time often result in monetary loss and bad customer experience, along with affecting the brand reputation of banks, merchants, and payment networks. As per the statistics, a new victim of identity theft occurs every 2 seconds. Additionally, there is a sudden increase in card-not-present (CNP) fraud. Generally, CNP fraud is a category of fraud made via online payment transactions, telephone, or mail. More specifically, CNP fraud refers to payment transactions that are performed where a card is not presented to a merchant for a visual check. In an example, there is an 81% more likelihood of a CNP fraud as compared to that of a point-of-sale (POS) fraud. As per a report, there was a global loss of around 20 billion US dollars due to fraudulent e-commerce transactions worldwide in the year 2021.

Fraud detection in payment transactions is a very challenging task. Fraudulent transactions affect not only the merchant/vendor at which the transaction is performed, but also the authorizing bank, the cardholder itself, and the payment processing network/gateway. Generally, fraudsters keep utilizing very sophisticated techniques in online payment account fraud, where payment transactions do not appear like fraudulent transactions to the parties involved. For example, fraudsters can look and behave exactly how an authentic customer might be expected to look and behave while performing transactions. It is noted that fraudulent transactions result in the loss of billions of dollars globally, as well as also lead to reputational damage to the parties involved in the processing of payment transactions.

It is thus important to predict fraudulent payment transactions at the time of authorization and then raise an alert to the decision-making authority. Conventional fraud detection systems are mainly issuer-specific. More specifically, conventional fraud detection systems are trained based on the characteristics or features of issuer servers. For example, the conventional fraud detection systems utilize historical data (i.e., payment transactions) of cardholders to predict fraudulent payment transactions that may occur in the future. In other words, the conventional fraud detection systems utilize the sequential history of payment transactions performed by cardholders or customers to understand patterns of fraud.

There is a technological need for a technical solution for predicting fraudulent transactions based on characteristics modeling of acquirer servers.

### SUMMARY

Various embodiments of the present disclosure provide methods and systems for predicting fraudulent payment transactions at an acquirer-level.

In an embodiment, a computer-implemented method is disclosed. The method includes accessing, by a server system, historical transaction data of payment transactions associated with an acquirer server from a transaction database. In addition, the method includes determining, by the server system, acquirer features associated with the acquirer server and transaction features associated with an individual payment transaction based, at least in part, on the historical transaction data. The method further includes generating, by the server system via an embedding layer, a latent representation corresponding to the individual payment transaction based, at least in part, on the acquirer features and the transaction features. Furthermore, the method includes training, by the server system, a fraud classifier and an acquirer classifier based, at least in part, on the latent representation and a multi-component event-aware loss function. The training is performed by executing a plurality of operations. The plurality of operations includes computing, by the server system, the multi-component event-aware loss function based, at least in part, on the execution of the fraud classifier and the acquirer classifier. Moreover, the plurality of operations includes updating, by the server system, network parameters of the fraud classifier, the acquirer classifier, and the embedding layer based, at least in part, on the multi-component event-aware loss function.

Other aspects and example embodiments are provided in the drawings and the detailed description that follows.

### BRIEF DESCRIPTION OF THE FIGURES

For a more complete understanding of embodiments of the present technology, reference is now made to the following descriptions taken in connection with the accompanying drawings in which:

FIG. 1 illustrates an example representation of an environment, related to at least some embodiments of the present disclosure;

FIG. 2 illustrates a simplified block diagram of a server system, in accordance with an embodiment of the present disclosure;

FIG. 3 illustrates a schematic block diagram representation of multi-task acquirer-level characteristic modeling for prediction of fraudulent payment transactions, in accordance with an embodiment of the present disclosure;

FIG. 4 illustrates a table depicting performance metrics of a transaction monitoring model on a first synthetic dataset, in accordance with an embodiment of the present disclosure;

FIG. 5 illustrates a table depicting performance metrics of the transaction monitoring model on a second synthetic dataset, in accordance with an embodiment of the present disclosure;

FIG. 6 illustrates a table depicting contribution of each loss component in the multi-component event-aware loss function, in accordance with an embodiment of the present disclosure;

FIG. 7 illustrates a flow diagram depicting a method for training of the transaction monitoring model, in accordance with an embodiment of the present disclosure; and

FIG. 8 illustrates a simplified block diagram of an acquirer server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through the use of cash substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform as payment networks include those operated by such as Mastercard®.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “cardholder”, “user”, and “customer” are used interchangeably throughout the description and refer to a person who holds a payment card (e.g., credit card, debit card, etc.) that will be used by a merchant to perform a payment transaction.

The terms “event”, “transaction”, and “payment transaction” are used interchangeably throughout the description and refer to a payment transaction being initiated by the cardholder.

### OVERVIEW

Various embodiments of the present disclosure provide methods, systems electronic devices, and computer program products for training a transaction monitoring model based on a multi-component event-aware loss function.

As stated above, the number of fraudulent payment transactions is increasing day by day, resulting in a larger number of affected individuals and higher revenue loss. In addition, the affected individuals may request their account closure after suffering from monetary losses due to fraudulent payment transactions. Therefore, the development of a fraud payment transaction prediction model is an important task with large-scale real-world applicability and wide-scale impact.

Generally, a transaction monitoring model is trained to output a score for each payment transaction. Based on the score, the transaction monitoring model predicts whether the payment transaction is fraudulent. For example, if the score is at least equal to (i.e., greater than or equal to) a pre-defined threshold score, the transaction may be considered fraudulent, otherwise, the payment transaction may be considered non-fraudulent.

In general, fraudulent transaction prediction problems can be termed sequential or time-series-based problems. Given the sequential/time-series-based behavior of cardholders, most of the conventional transaction monitoring models focus on modeling the previous history of the user using sequential models. In addition, the conventional models focus on modeling the relationship between the different entities (such as cardholders and merchants) in the payment network using spatial/relational models. While such models focus on capturing the different patterns observed in the data, such models do not focus on incorporating domain-specific business knowledge for generating robust transaction monitoring models, suitable for applicability in the real world.

In view of the foregoing, various embodiments of the present disclosure provide methods, systems, user devices, and computer program products for training a transaction monitoring model based on a novel multi-component event-aware loss function. The loss function incorporates domain knowledge by modeling the transaction patterns while optimizing for the overall fraud predictions, net benefit (related to cost saving), and effective classification performance. Further, since fraud patterns often change over time, the proposed loss function focuses on providing more importance to recent payment transactions to ensure recency-based model learning. Furthermore, the loss function can easily be implemented in various architectures, thereby making itself model-agnostic and supporting quick real-time inference.

The present disclosure describes a server system configured to train a transaction monitoring model based, at least in part, on the multi-component event-aware loss function. In one non-limiting example, the server system is a payment server.

Initially, the server system is configured to access historical transaction data of payment transactions associated with an acquirer server from a transaction database. The payment transactions may have been performed in an interval of time (e.g., 6 months, 9 months, 1 year, 2 years, etc.). The historical transaction data includes information of both fraudulent and non-fraudulent payment transactions performed at the acquirer server. The server system is then configured to determine acquirer features associated with the acquirer server and transaction features associated with an individual payment transaction based, at least in part, on the historical transaction data.

The server system is further configured to generate, via an embedding layer, a latent representation corresponding to the individual payment transaction based, at least in part, on the acquirer features and the transaction features. Furthermore, the server system is configured to train a fraud classifier and an acquirer classifier based, at least in part, on the latent representation and the multi-component event-aware loss function. The training is performed by executing a plurality of operations. The fraud classifier is configured to classify whether the individual payment transaction is fraudulent. The acquirer classifier is configured to classify whether the acquirer server is fraudulent.

The plurality of operations includes computing the multi-component event-aware loss function based, at least in part, on the execution of the fraud classifier and the acquirer classifier. Moreover, the plurality of operations includes updating network parameters of the fraud classifier, the acquirer classifier, and the embedding layer based, at least in part, on the multi-component event-aware loss function.

In an embodiment, the multi-component event-aware loss function is a combination of a recency-based cross-entropy loss component, an acquirer classification loss component, a predicted event rate (PER) optimization loss component, and a net benefit loss component. The recency-based cross-entropy loss component assigns a first weightage to recent payment transactions and a second weightage to older payment transactions. The first weightage is greater than the second weightage.

The acquirer classification loss component represents a value calculated based, at least in part, on the acquirer features associated with the acquirer server. The PER optimization loss component is defined as a ratio of the count of fraudulent payment transaction predictions to the total count of predictions. The fraud classifier, the acquirer classifier, and the embedding layer are comprised in the transaction monitoring model.

The fraud classifier is selected from the group including long short-term memory (LSTM) architecture, recurrent neural network (RNN) architecture, and multi-layer perceptron (MLP) architecture. The acquirer classifier is selected from the group including long short-term memory (LSTM) architecture, recurrent neural network (RNN) architecture, and multi-layer perceptron (MLP) architecture.

Various embodiments of the present disclosure offer multiple advantages and technical effects. For instance, the present disclosure provides a system for training a transaction monitoring model based on a novel multi-component event-aware loss function. The loss function utilizes key domain-specific knowledge for optimizing the number of fraud predictions over a batch of transactions. This further ensures that the transaction monitoring model is deployable in real-world setups without hampering the customer experience (i.e., by not raising too many false alarms). In addition, the loss function is model agnostic and can be applied to multiple backbone architectures (such as Multi-Layer Perceptron (MLP), Long Short-Term Memory (LSTM), or Recurrent Neural Network (RNN)).

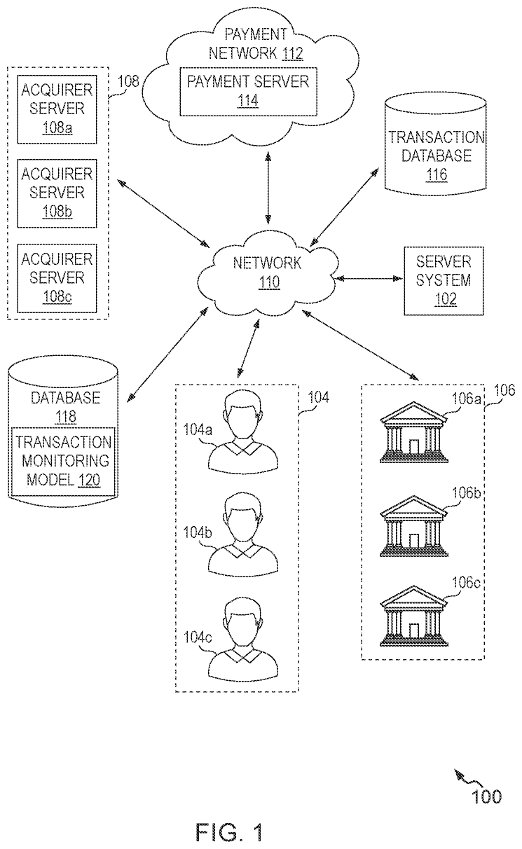

Various embodiments of the present disclosure are described hereinafter with reference to FIGS. 1 to 8.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, predicting card-not-present (CNP) fraudulent payment transactions based on modeling of acquirer-level characteristics. The environment 100 generally includes a server system 102, a plurality of cardholders 104a, 104b, and 104c (collectively, referred to as cardholders 104), a plurality of merchants 106a, 106b, and 106c (collectively, referred to as merchants 106), a plurality of acquirer servers 108a, 108b, and 108c (referred to as an acquirer server 108 for the sake of simplicity), a payment network 112 including a payment server 114, and a transaction database 116, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Con-trol Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, any combination thereof or any future communication protocols. For example, the network 110 may include multiple different networks, such as a private network or a public network (e.g., the Internet, etc.) through which the server system 102 and the payment server 114 may communicate.

In one scenario, the cardholders 104 may use their corresponding payment accounts to conduct payment transactions with the merchants 106. In an example, the cardholder 104a may enter payment account details on a mobile device to perform an online payment transaction. In another example, the cardholder 104b may utilize a payment card to perform an offline payment transaction. Generally, “payment transaction” refers to an agreement that is carried out between a buyer and a seller to exchange assets as a form of payment (e.g., cash, currency, etc.). For example, the cardholder 104c may enter details of payment card on an e-commerce platform to buy goods. In an example, each cardholder (e.g., the cardholder 104a) may transact at the merchants 106.

The cardholder (e.g., the cardholder 104a) may be any individual, representative of a corporate entity, non-profit organization, or any other person that is presenting payment account details during an electronic payment transaction. The cardholder (e.g., the cardholder 104a) may have a payment account issued by an issuing bank (not shown in figures) and may be provided a payment card with financial or other account information encoded onto the payment card such that the cardholder (i.e., the cardholder 104a) may use the payment card to ini-tiate and complete a payment transaction using a bank account at the issuing bank.

The cardholders 104 may use their corresponding user devices (not shown in figures) to access a mobile application or a website associated with the issuing bank, or any third-party payment application. The user devices may refer to any electronic devices such as, but not limited to, personal computers (PCs), tablet devices, Personal Digital Assistants (PDAs), voice-activated assistants, Virtual Reality (VR) devices, smartphones, and laptops.

In one embodiment, the cardholders 104 are associated with an issuer server. In one embodiment, the issuer server is associated with a financial institution normally called an “issuer bank”, “issuing bank” or simply “issuer”, in which a cardholder (e.g., the cardholder 104a) may have a payment account, (which also issues a payment card, such as a credit card or a debit card), and provides microfinance banking services (e.g., payment transaction using credit/debit cards) for processing electronic payment transactions, to the cardholder (e.g., the cardholder 104a).

The merchants 106 may include retail shops, restaurants, supermarkets or estab-lishments, government and/or private agencies, or any such places equipped with POS terminals, where customers visit for performing the financial transaction in exchange for any goods and/or services or any financial transactions.

In an embodiment, the merchants 106 are associated with the acquirer server 108. In an embodiment, each merchant (e.g., the merchant 106a) is associated with an acquirer server (e.g., the acquirer server 108a). In one embodiment, the acquirer server 108 is associated with a financial institution (e.g., a bank) that processes financial transactions. This can be an institution that facilitates the processing of payment transactions for physical stores, merchants (e.g., the merchants 106), or institutions that own platforms that make either online purchases or purchases made via software applications possible (e.g., shopping cart platform providers and in-app payment processing providers). The terms “acquirer”, “acquiring bank”, “acquiring bank” or “acquirer server” will be used interchangeably herein.

In an embodiment, the transaction database 116 is communicatively coupled to the server system 102. In one embodiment, the transaction database 116 may include multifari-ous data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data.

In an example, the transaction database 116 stores merchant profile data associated with the merchants 106. In one embodiment, the merchant profile data may include data such as the name of the merchants 106, transaction information of the cardholders 104 at a particular merchant (e.g., the merchant 106a), information of fraudulent or non-fraudulent transactions performed at the merchants 106, various terminals (e.g., point-of-sale (POS) devices, automated teller machines (ATMs), etc.) associated with each merchant (e.g., the merchant 106a), and the like.

In yet another example, the transaction database 116 stores real-time transaction data of the cardholders 104. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past ‘x’ number of days to a particular user, transaction location information, external data sources, and other internal data to evaluate each transaction.

In one embodiment, the server system 102 is configured to perform one or more of the operations described herein. In one non-limiting example, the server system 102 is the payment server 114. The server system 102 is configured to train a transaction monitoring model 120 based, at least in part, on a multi-component event-aware loss function while incorporating key domain-specific characteristics during training. During the implementation phase, the server system 102 is configured to monitor the payment transactions performed in real-time before authorization and predict whether the payment transaction is fraudulent.

The environment 100 also includes a database 118 storing the transaction monitoring model 120. In particular, the database 118 provides a storage location for data and/or metadata associated with the transaction monitoring model 120. The server system 102 is configured to train the transaction monitoring model 120 based, at least in part, on the multi-component event-aware loss function. In one embodiment, the server system 102 is configured to implement the trained transaction monitoring model 120 to predict whether a payment transaction is fraudulent in real-time. In one embodiment, the transaction monitoring model 120 is configured to implement a fraud prediction algorithm in real time while modeling key characteristics of fraudulent transactions in order to have high detection rates.

In one embodiment, the payment network 112 may be used by the payment card issuing authorities as a payment interchange network. Examples of payment interchange networks include but are not limited to, Mastercard® payment system interchange network. The Mastercard® payment system interchange network is a proprietary communications standard promulgated by Mastercard International Incorporated® for the exchange of electronic payment transaction data between issuers and acquirers that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distrib-uted systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

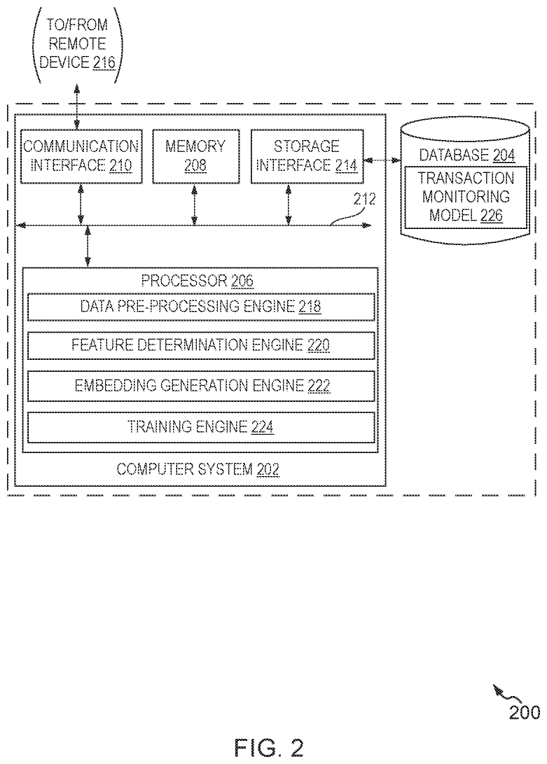

Referring now to FIG. 2, a simplified block diagram of a server system 200 is illustrated, in accordance with an embodiment of the present disclosure. The server system 200 is an example of the server system 102. In one embodiment, the server system 200 is a part of the payment network 112 or integrated within the payment server 114. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, and a storage interface 214 that communicate with each other via a bus 212.

In some embodiments, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Ad-vanced Technology Attachment (ATA) adapter, a Serial ATA (SATA) adapter, a Small Com-puter System Interface (SCSI) adapter, a RAID controller, a SAN adapter, a network adapter, and/or any component providing the processor 206 with access to the database 204. In one non-limiting example, the database 204 is configured to store a transaction monitoring model 226. The transaction monitoring model 226 is identical to the transaction monitoring model 120 of FIG. 1.

The processor 206 includes suitable logic, circuitry, and/or interfaces to execute operations for accessing historical transaction data of payment transactions associated with the acquirer server 108. Examples of the processor 206 include, but are not limited to, an applica-tion-specific integrated circuit (ASIC) processor, a reduced instruction set computing (RISC) processor, a graphical processing unit (GPU), a complex instruction set computing (CISC) processor, a field-programmable gate array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 216 such as the acquirer server 108 or communicating with any entity connected to the network 110 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing engine 218, a feature determination engine 220, an embedding generation engine 222, and a training engine 224. It should be noted that the components, described herein, such as the data pre-processing engine 218, the feature determination engine 220, the embedding generation engine 222, and the training engine 224 can be configured in a variety of ways, including electronic circuit-ries, digital arithmetic and logic blocks, and memory systems in combination with software, firmware, and embedded technologies.

The data pre-processing engine 218 includes suitable logic and/or interfaces for accessing historical transaction data of payment transactions associated with the acquirer server 108 from the transaction database 116. In particular, the historical transaction data may include information of payment transactions performed by the cardholders 104 at the merchants 106 associated with the acquirer server 108. The payment transactions may be performed within an interval of time (e.g., 6 months, 12 months, 24 months, etc.). In an embodiment, the historical transaction data includes information of both fraudulent and non-fraudulent payment transactions performed at the acquirer server 108.

In some non-limiting examples, the historical transaction data includes merchant name identifier, unique merchant identifier, timestamp information, geo-location data, information related to payment instruments involved in the payment transaction, and the like. In one example, historical transaction data may define a relationship between a cardholder account and a merchant account. For example, when a cardholder purchases an item from a merchant, a relationship is defined.

In an embodiment, the historical transaction data may include information related to past payment transactions such as, transaction date, transaction time, geo-location of transaction, transaction amount, transaction marker (e.g., fraudulent or non-fraudulent), and the like. In another embodiment, the historical transaction data may include information related to the acquirer server 108 such as, the date of merchant registration with the acquirer server 108, amount of payment transactions performed at the acquirer server 108 in a day, number of payment transactions performed at the acquirer server 108 in a day, maximum transaction amount, minimum transaction amount, number of fraudulent merchants or non-fraudulent merchants registered with the acquirer server 108, and the like. The data pre-processing engine 218 then transmits the historical transaction data to the feature determination engine 220.

The feature determination engine 220 includes suitable logic and/or interfaces for determining acquirer features associated with the acquirer server 108 and transaction features associated with an individual payment transaction based, at least in part, on the historical transaction data. In particular, the feature determination engine 220 is configured to determine the acquirer features corresponding to the acquirer server 108 based on the historical transaction data. In addition, the feature determination engine 220 is configured to determine the transaction features corresponding to each payment transaction in the historical transaction data.

In an embodiment, the data pre-processing engine 218 may perform the featurization process over the historical transaction data for determining a feature vector corresponding to the individual payment transaction (i.e., each payment transaction) associated with the acquirer server 108 based, at least in part, on the historical transaction data.

The feature determination engine 220 may include a machine learning model such as, but not limited to, Linear Discriminant Analysis (LDA) model, Independent Component Analysis (ICA) model, or Principal Component Analysis (PCA) model to perform the featurization process. The feature determination engine 220 then transmits the feature vector to the embedding generation engine 222.

The embedding generation engine 222 includes suitable logic and/or interfaces for generating, via an embedding layer, a latent representation corresponding to the individual payment transaction based, at least in part, on the acquirer features and the transaction features. The latent representation herein may correspond to a simplified representation of input data (simplified such that it can be fed as input to a neural network architecture for processing).

In particular, the embedding generation engine 222 receives the acquirer features and the transaction features as input. In addition, the embedding generation engine 222 passes the acquirer features and the transaction features through the embedding layer. Further, the embedding generation engine 222 is configured to determine the latent representation of the individual payment transaction based on the processing of the acquirer features and the transaction features. The embedding generation engine 222 then transmits the latent representation to the training engine 224.

The training engine 224 includes suitable logic and/or interfaces for training a fraud classifier and an acquirer classifier based, at least in part, on the latent representation and a multi-component event-aware loss function. To train the fraud classifier and the acquirer classifier, the training engine 224 is configured to perform the training by executing a plurality of operations.

The plurality of operations includes computing the multi-component event-aware loss function based, at least in part, on the execution of the fraud classifier and the acquirer classifier. The fraud classifier is configured to classify whether the individual payment transaction is fraudulent. Moreover, the acquirer classifier is configured to classify whether the acquirer server 108 is fraudulent.

The training engine 224 is then configured to update network parameters (e.g., weights, biases, etc.) of the fraud classifier, the acquirer classifier, and the embedding layer based, at least in part, on the multi-component event-aware loss function. In particular, the training engine 224 is configured to update neural network parameters up to the embedding layer based, at least in part, on the multi-component loss function.

The multi-component event-aware loss function is a combination of a recency-based cross-entropy loss component, an acquirer classification loss component, a predicted event rate (PER) optimization loss component, and a net benefit loss component. In other words, the recency-based cross-entropy loss component assigns a first weightage to recent payment transactions and a second weightage to older payment transactions. In addition, the first weightage is greater than the second weightage.

The acquirer classification loss component represents a value calculated based, at least in part, on the acquirer features associated with the acquirer server 108. The PER optimization loss component is defined as a ratio of the count of fraudulent payment transaction predictions to a total count of predictions. In an embodiment, the fraud classifier, the acquirer classifier, and the embedding layer are included in the transaction monitoring model 226.

In an embodiment, the fraud classifier is selected from the group including long short-term memory (LSTM) architecture, recurrent neural network (RNN) architecture, and multi-layer perceptron (MLP) architecture. In an embodiment, the acquirer classifier is selected from the group including long short-term memory (LSTM) architecture, recurrent neural network (RNN) architecture, and multi-layer perceptron (MLP) architecture.

In one implementation, the recency-based cross-entropy loss component (which can also be termed as recency-based classification loss) provides more weightage to recent payment transactions and less weightage to past payment transactions. In an example, the recency-based cross-entropy loss component is a value calculated based on an attention mechanism. The attention mechanism provides more attention to a recent payment transaction and lesser attention to previous payment transactions as per their time of occurrence. For example, a payment transaction performed 3 days ago may be assigned 72% attention, a payment transaction performed 30 days ago may be assigned 46% attention, and a payment transaction performed 60 days ago may be assigned 12% weightage.

The recency-based classification loss component may be calculated as:

$$LRecency = {\sum }_{i = 1}^{n} λ * C rossEntropy ( {y}_{i}^{′} , {y}_{i} ) \qquad Eqn . ( 1 )$$

$$Where λ = \frac{{t}_{i}}{Transactionduration} \qquad Eqn . ( 2 )$$

In one implementation, the acquirer classification loss component represents a value calculated based on the modeling of acquirer-level characteristics (e.g., the acquirer features) of the acquirer server 108. In one implementation, the acquirer classification loss component may be calculated as:

LACL=Σⁿᵢ₌₁β*CrossEntropy(aᵢ′,aᵢ) Eqn. (3)

In one representation, the PER optimization loss component is optimized in such a manner that the number of predicted frauds must be closer to the actual number of frauds. In other words, the transaction monitoring model 226 must not predict too many or too few fraudulent transactions. The PER optimization loss component may be calculated as:

$$LPER = γ * ( r - \frac{\sum {y}^{′}}{n} ) \hat{} 2 \qquad Eqn . ( 4 )$$

In one implementation, the net benefit loss component is related to the business implementation of the transaction monitoring model 226. In an example, the net benefit loss component may differ based on various currencies. In addition, the net benefit loss component may differ based on a pre-defined value. The pre-defined value may correspond to a commission value.

In one implementation, the net benefit loss component can be calculated as:

LNET=α*(Σⁿᵢ₌₁₍USDᵢ∨(γᵢ=γᵢ′=1)−0.03*USDᵢ∨(γᵢ=0∧γᵢ′=1)|) Eqn. (5)

Where 0.03 is a variable amount that can vary as per the commission value. Where USD stands for US dollar and may vary based on a different currency. The net benefit loss component facilitates the transaction monitoring model 226 to operate without losing much amount in commissions.

In one non-limiting example, the embedding layer is a Rectified Linear Unit (ReLU) layer. In one embodiment, the embedding layer is a linear layer. In a nutshell, the training engine 224 is configured to train the transaction monitoring model 226 based on the multi-component event-aware loss function.

Therefore, the multi-component event-aware loss function may be calculated as:

$$Loss = {\sum }_{i = 1}^{n} ) + γ * ( r - \frac{\sum {y}^{′}}{n} ) \hat{} 2 - α * ( {\sum }_{i = 1}^{n} ( U S {D}_{i} ∨ ( {y}_{i} = {y}_{i}^{′} = 1 ) - 0.03 * U S {D}_{i} ∨ ( {y}_{i} = 0 ∧ {y}_{i}^{′} = 1 ) \vert ) \qquad Eqn . ( 6 )$$

Where, α, β, and γ are loss weights.

Once the training is complete, the server system 200 may run or implement the transaction monitoring model 226 to predict whether the payment transaction performed in real-time is fraudulent. In one implementation, the server system 200 may also predict whether the acquirer server 108 is fraudulent. Initially, the server system 200 may receive a pre-authorization payment request from a payment gateway (not shown in the figures). The server system 200 may then implement the trained transaction monitoring model 226 to predict whether the payment transaction is fraudulent or not. In addition, the transaction monitoring model 226 may predict whether the acquirer server 108 associated with the payment transaction is fraudulent.

To implement the transaction monitoring model 226, the server system 200 will access the historical payment transaction data associated with the acquirer server 108. In addition, the server system 200 will access the payment transaction data associated with the real-time payment transaction (i.e., payment transactions occurring in real-time). The server system 200 then inputs the historical payment transaction data and the real-time payment transaction data in the transaction monitoring model 226. The transaction monitoring model 226 may then generate the latent representation for the real-time payment transaction based on the embedding layer.

The latent representation is further fed as an input to the fraud classifier and the acquirer classifier. The fraud classifier outputs a prediction of whether the real-time payment transaction is fraudulent or not. Similarly, the acquirer classifier predicts an acquirer based on the latent representation. In one embodiment, the prediction may be in the form of a binary value. For example, a prediction of 0 may represent non-fraudulent and a prediction of 1 may represent fraudulent.

The server system 200 may then transmit a notification to the payment server 114. The notification may include the prediction of whether the real-time payment transaction is fraudulent. Additionally, the notification may include the prediction of whether the acquirer server 108 is fraudulent.

In a nutshell, the server system 200 incorporates domain-specific knowledge for training the transaction monitoring model 226 based, at least in part, on the multi-component event-aware loss function. The trained transaction monitoring model 226 may output a riskiness score for each payment transaction, determining whether it is fraudulent or not.

The multi-component event-aware loss function focuses on increasing the net benefit (in terms of revenue) which is often a function of the true positives, false positives, and false negatives. In addition, the proposed loss function focuses on minimizing the total fraud predictions (in order to reduce false positives) such that the transaction monitoring model 226 provides confident predictions. Further, the transaction monitoring model 226 gives higher importance to recent transactions (i.e., recency-based learning). Furthermore, the inclusion of a business-specific loss component allows the transaction monitoring model 226 to be deployable while supporting a smaller model for quick real-time inference.

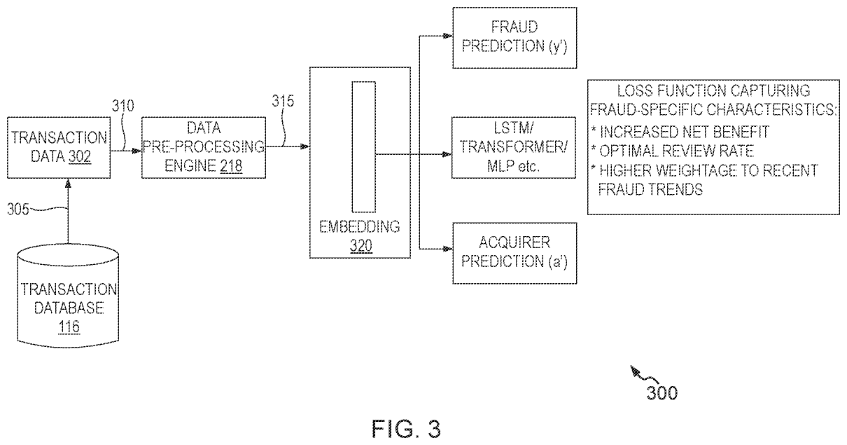

FIG. 3 illustrates a schematic block diagram representation 300 of multi-task acquirer-level characteristic modeling for prediction of fraudulent payment transactions, in accordance with an embodiment of the present disclosure.

As discussed above, transaction data is accessed from the transaction database 116 (see, 305). In an embodiment, the transaction data 302 includes information of payment transactions associated with the acquirer server 108. For example, the transaction data 302 may include information of payment transactions performed via the cardholders 104 at the merchants 106 associated with the acquirer server 108.

The transaction data 302 is then fed as input to the data pre-processing engine 218 (see, 310). With reference to FIG. 2, the data pre-processing engine 218 is configured to perform data pre-processing operations on the transaction data 302. In an embodiment, the data pre-processing engine 218 is configured to perform the featurization process over the transaction data 302. In particular, the data pre-processing engine 218 is configured to generate the acquirer features and the transaction features from the transaction data 302.

The acquirer features and the transaction features are then fed as an input to the transaction monitoring model 226 (see, 315). The transaction monitoring model 226 is further configured to generate, via the embedding layer, a latent representation corresponding to the payment transaction (see, embedding 320). In one embodiment, the embedding layer is a linear layer. In one embodiment, the embedding layer is a logit layer.

In general, a loss function measures the difference between the expected and predicted outputs. It is always required to minimize the loss function. To develop robust models, it is necessary to identify important aspects that need to be optimized that can be included in the loss function. For example, the dollar amount saved (i.e., the net benefit) is more important than cross-entropy loss values. It is noted that these two might be related but are not always 100% correlated. Furthermore, the loss functions are mainly optimized using gradient descent while training. To satisfy the above-mentioned requirements, the server system 200 is configured to train the transaction monitoring model 226 based on the multi-component event-aware loss function.

The multi-component loss function includes a recency-based cross-entropy loss component (LRecency). In general, transaction fraud prediction can be considered a two-class classification problem (fraud or non-fraud). In conventional classification loss functions, the underlying architecture uses standard cross-entropy loss for learning an effective classifier. However, the financial datasets often witness variations in the transaction patterns which are essential to the model.

Therefore, the recency-based cross-entropy loss component introduces a recency factor during the training of the transaction monitoring model 226. The recency factor focuses on providing more weightage to the recent payment transactions as compared to the older payment transactions, thereby ensuring that the transaction monitoring model 226 can capture recent fraud trends. Mathematically, given a prediction γᵢ′ for a target γᵢ, a recency weight of Δtᵢ can be calculated as:

$$LRecency = \sum \frac{{y}_{i} * log {y}_{i}^{′}}{Δ {t}_{i}} \qquad Eqn . ( 7 )$$

It is to be noted that the recency weight is inversely proportional to the duration of the current payment transaction from the last payment transaction, thus resulting in higher weightage to the most recent payment transactions.

In addition, the multi-component loss function includes a predicted event rate (PER) optimization loss component (LPER). The PER is defined as a count of fraudulent payment predictions over the count of total observations. On the other hand, the True Event Rate (TER) can be defined as the count of true frauds over the count of total observations. In an ideal scenario, the transaction monitoring model 226 should produce a PER closer to TER, thus resulting in lesser false positives and promoting itself to predict the under-sampled class (i.e., the fraud class). Mathematically, the LPER can be defined as:

LPER=(r−MSE0n)) Eqn. (8)

Where, r is the true event rate and 0n=(0, 0, . . . , 0) ∈ Rn is a zero vector. The PER optimization loss component thus promotes the PER of the transaction monitoring model 226 to be as close as possible to the TER.

Further, the multi-component loss function includes a net benefit loss component (LNET). It is to be noted that the net benefit loss component is one of the most important business metrics for the fraud prediction domain. Generally, when any transaction monitoring model (e.g., the transaction monitoring model 226) is deployed, it would provide recommendations for blocking payment transactions that appear to be fraudulent. For a true positive event (i.e., the actual fraud), the transaction monitoring model 226 will save the total sum of the amount of such payment transactions. On the other hand, for a false positive event (i.e., the incorrect fraud prediction), the transaction monitoring model 226 will lose out on the x % transaction processing fee that it would have gained by allowing the payment transaction through.

Therefore, the net benefit can be viewed as the difference between the dollar amount of the true positive payment transactions and x % of the dollar amount of the false positive payment transactions. For generality, the net benefit loss component is defined as a function of the true positive payment transactions and the false positive payment transactions. Mathematically, the net benefit loss component can be represented as:

LNET=f(true positives,false positives) Eqn. (9)

The multi-component event-aware loss can be represented as LEML. The LEML is thus a combination of LRECENCY, LPER, and LNET by using relevant hyper-parameters (α, β, γ). Therefore, the multi-component event-aware loss function can be mathematically defined as:

$$LEML ( {y}_{i}^{′} , {y}_{i} ) = α * \sum \frac{{y}_{i} * log {y}_{i}^{′}}{Δ {t}_{i}} + β * ( r - MSE 0 n ) ) + γ * f ( true positives , false positives ) \qquad Eqn . ( 10 )$$

Therefore, the above-defined loss function enables the learning of a robust transaction monitoring model 226 while incorporating the domain-specific business trends and requirements.

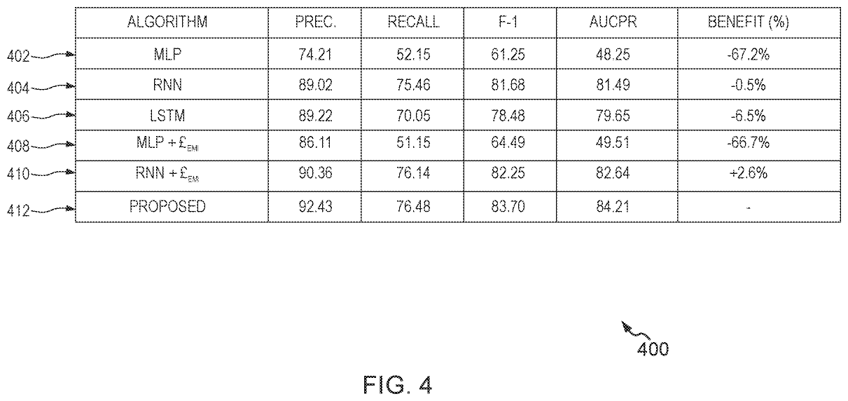

FIG. 4 illustrates a table 400 depicting performance metrics of the transaction monitoring model 226 on a first synthetic dataset, in accordance with an embodiment of the present disclosure.

Experiments have been performed on the first synthetic dataset with varying underlying architectures (such as long short-term memory (LSTM), multi-layer perceptron (MLP), and recurrent neural network (RNN)) along with the detailed analysis of the multi-component loss (i.e., LEML). The first synthetic dataset includes synthetically generated 24M credit card transactions from around 20,000 cardholders. In an example, the transactions have been generated using rule-based generators, where the values are generated using stochastic sampling techniques.

It is noted that each transaction has 12 fields including both continuous and discrete nominal attributes, such as transaction amount, merchant location, transaction date, and the like. In addition, samples are generated by combining 10 contiguous rows (with a stride of 10) in a time-dependent manner for each cardholder. Since the data is heavily imbalanced, up-sampling is used to roughly equalize the frequencies of both fraud and non-fraud classes.

The table 400 depicts the performance metrics (i.e., precision, recall, F1-score, and AUCPR) of a multi-layer perceptron (MLP) model without the proposed loss function (i.e., the multi-component event-aware loss function) (see, 402). In addition, the table 400 depicts the performance metrics of a recurrent neural network (RNN) model without the proposed loss function (see, 404). Further, the table 400 depicts the performance metrics of a long short-term memory (LSTM) model without the proposed loss function (see, 406).

Furthermore, the table 400 depicts the performance metrics of a multi-layer perceptron (MLP) model with the proposed loss function (see, 408). Moreover, the table 400 depicts the performance metrics of a recurrent neural network (RNN) model with the proposed loss function (see, 410). Also, the table 400 depicts the performance metrics of a long short-term memory (LSTM) model with the proposed loss function (see, 412).

As shown in the table 400, the multi-component event-aware loss function shows improved performance on the first synthetic dataset as compared to other models. In particular, the loss function (in LSTM model) achieves a precision and recall of 92.4 and 76.4, respectively, demonstrating significant improvement from the LSTM model (trained only with the cross-entropy loss) which obtains an F-1 score of 79.6, which is around 5% lower than the proposed transaction monitoring model 226.

Although an F-1 score of 0.86 has been reported on the first synthetic dataset, however, it is to be noted that a different protocol (exact splits are not available) is followed and additional steps of up-sampling are performed during training. To summarize, any model architecture (along with the proposed loss function) presents an improvement of around 3% from the baseline model (i.e., a similar model without the proposed loss function). In addition, an improvement of around 5% is observed in the LSTM architecture (along with the proposed loss function) from the base LSTM architecture (without the proposed loss function).

It is noted that the efficacy of the proposed loss function has been demonstrated by using different backbone architectures (i.e., MLP, RNN, and LSTM), where, training with the proposed loss function demonstrates improvement as compared to training with any conventional loss function already known in the art. The table 400 depicts the performance comparison on different backbone architectures with and without the proposed loss function. The improved performance (in terms of performance metrics) thus supports the model-agnostic behavior of the proposed loss function. In fact, the benefit of using sequential models is also visible across different architectures, where a difference of at least 15% in precision is observed between the MLP architecture and the RNN/LSTM architectures. It is also noted that the best performance is obtained by the combination of an LSTM architecture with the proposed loss function in terms of the performance metrics.

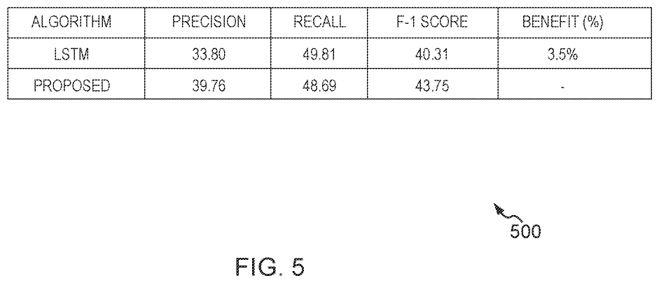

FIG. 5 illustrates a table 500 depicting performance metrics of the transaction monitoring model 226 on a second synthetic dataset, in accordance with an embodiment of the present disclosure.

Experiments have been performed on the second synthetic dataset generated based on real-world distribution of actual frauds. The dataset includes around 1 M transactions from 37,500 unique cardholders with 28,000 unique merchants and has a total of 67,580 fraudulent transactions. Every transaction includes 298 unique fields like transaction time, merchant id, and the like. In addition, sequences of time, amount, and other fields are created in the input for each cardholder, ordered by time, and then passed onto the model architecture. The complete dataset is further divided into training, validation, and testing set having 70%, 10%, and 20% of transactions, respectively.

It is to be noted that the experiments have been performed with an LSTM base architecture including two hidden layers, followed by two dense (fully connected) layers for classification.

In the table 500, a performance comparison between the proposed loss function (with LSTM architecture, for example) and the baseline model (e.g., LSTM without the proposed loss function) is shown. It can be observed that the F1-score has been increased from 40.3 to 43.7, along with an increase in the precision (from 33.8 to 39.7) for the fraud class when using the proposed loss function. Also, an improvement of around +3.5% is observed for the overall net benefit.

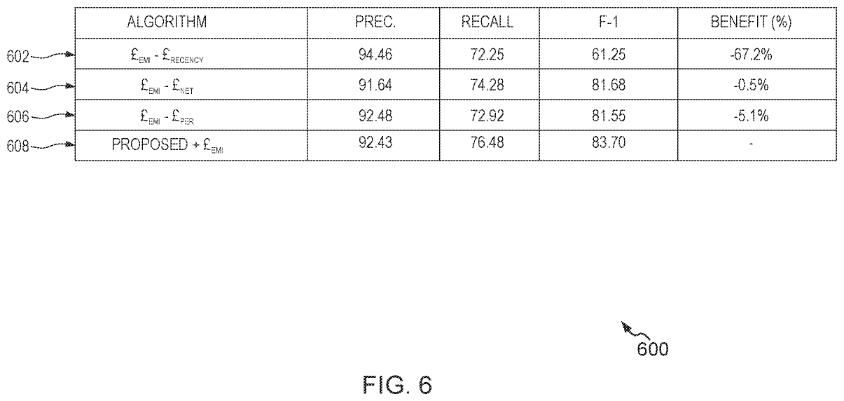

FIG. 6 illustrates a table 600 depicting the contribution of each loss component in the multi-component event-aware loss function, in accordance with an embodiment of the present disclosure. It is noted that experiments have been performed to understand the contribution of each loss component by removing them from the proposed loss function and reporting the performance metrics.

The table 600 shows the calculation of performance metrics (i.e., precision, recall, F-1 score, and Benefit (%)) for the multi-component event-aware loss function and for the loss function without a specific loss component. For example, the table 600 shows the performance metrics for the proposed loss function without the recency-based cross-entropy loss component (see, 602). In addition, the table 600 shows the performance metrics for the proposed loss function without the net benefit loss component (see, 604). Further, the table 600 shows the performance metrics for the proposed loss function without the PER optimization loss component (see, 606). Furthermore, the table 600 shows the performance metrics for the proposed loss function (see, 608).

As shown in FIG. 6, the removal of any component from the loss function results in a loss in performance. In addition, the maximum drop in performance is observed upon removing the PER loss component, resulting in a drop in the F-1 score from 83.70 to 81.55. The performance drop appears intuitive in nature since the PER component controls the total fraud predictions, thus pushing toward lesser false positives. On the other hand, the minimal impact is seen upon removing the recency-based component, where a drop in the F-1 score is accom-panied with a slight increase (0.7%) in the net benefit.

From FIG. 4, FIG. 5, and FIG. 6, it is observed that the proposed loss function results in improved performance metrics of the underlying architecture. This improved performance strengthens its usage for real-time fraud prediction, while providing flexibility during model training.

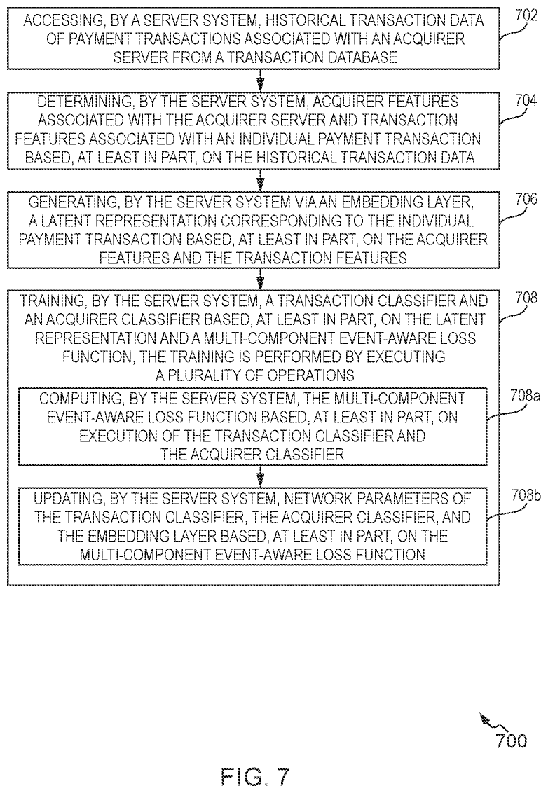

FIG. 7 illustrates a flow diagram depicting a method 700 for training of the transaction monitoring model 226, in accordance with an embodiment of the present disclosure. The method 700 depicted in the flow diagram may be executed by, for example, the server system 200. Operations of the method 700, and combinations of operation in the method 700, may be implemented by, for example, hardware, firmware, a processor, circuitry and/or a different device associated with the execution of software that includes one or more computer program instructions. The operations of the method 700 are described herein may be performed by an application interface that is hosted and managed with help of the server system 200. The method 700 starts at operation 702.

At operation 702, the method 700 includes accessing, by the server system 200, historical transaction data of payment transactions associated with the acquirer server 108 from the transaction database 116.

At operation 704, the method 700 includes determining, by the server system 200, acquirer features associated with the acquirer server 108 and transaction features associated with an individual payment transaction based, at least in part, on the historical transaction data.

At operation 706, the method 700 includes generating, by the server system 200 via the embedding layer, the latent representation corresponding to the individual payment transaction based, at least in part, on the acquirer features and the transaction features.

At operation 708, the method 700 includes training, by the server system 200, the fraud classifier and the acquirer classifier based, at least in part, on the latent representation and the multi-component event-aware loss function. The training is performed by executing a plurality of operations. The plurality of operations is explained below in 708a and 708b.

At operation 708a, the method 700 includes computing, by the server system 200, the multi-component event-aware loss function based, at least in part, on execution of the fraud classifier and the acquirer classifier.

At operation 708b, the method 700 includes updating, by the server system 200, network parameters of the fraud classifier, the acquirer classifier, and the embedding layer based, at least in part, on the multi-component event-aware loss function.

The sequence of operations of the method 700 need not to be necessarily executed in the same order as they are presented. Further, one or more operations may be grouped together and performed in form of a single step, or one operation may have several sub-steps that may be performed in parallel or in a sequential manner.

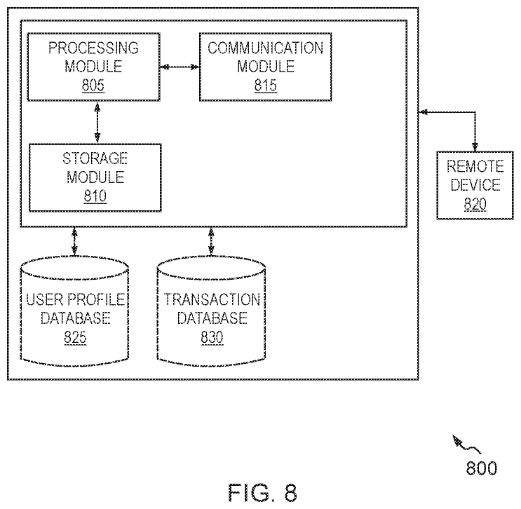

FIG. 8 illustrates a simplified block diagram of an acquirer server 800, in accordance with an embodiment of the present disclosure. The acquirer server 800 is an example of the acquirer server 108 of FIG. 1. The acquirer server 800 is associated with an acquirer bank/acquirer, in which a merchant may have an account, which provides a payment card. The acquirer server 800 includes a processing module 805 operatively coupled to a storage module 810 and a communication module 815. The components of the acquirer server 800 provided herein may not be exhaustive and the acquirer server 800 may include more or fewer components than those depicted in FIG. 8. Further, two or more components may be embodied in one single component, and/or one component may be configured using multiple sub-components to achieve the desired functionalities. Some components of the acquirer server 800 may be configured using hardware elements, software elements, firmware elements and/or a combination thereof.

The storage module 810 is configured to store machine-executable instructions to be accessed by the processing module 805. Additionally, the storage module 810 stores information related to, contact information of the merchant, bank account number, availability of funds in the account, payment card details, transaction details, and/or the like. Further, the storage module 810 is configured to store payment transactions.

In one embodiment, the acquirer server 800 is configured to store profile data (e.g., an account balance, a credit line, details of the cardholders 104, account identification information, payment card number) in the transaction database 116. The details of the cardholders 104 may include, but are not limited to, name, age, gender, physical attributes, location, registered contact number, family information, alternate contact number, registered e-mail ad-dress, etc.

The processing module 805 is configured to communicate with one or more remote devices such as a remote device 820 using the communication module 815 over a network such as the network 110 of FIG. 1. The examples of the remote device 820 include the server system 102, the payment server 114, the transaction database 116, or other computing systems of the acquirer server 800 and the like. The communication module 815 is capable of facilitating such operative communication with the remote devices and cloud servers using API (Applica-tion Program Interface) calls. The communication module 815 is configured to receive a payment transaction request performed by the cardholders 104 via the network 110. The processing module 805 receives a payment card information, a payment transaction amount, a customer information and merchant information from the remote device 820 (i.e., the payment server 114). The acquirer server 800 includes a user profile database 825 and a transaction database 830 for storing transaction data. The user profile database 825 may include information of cardholders. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

The disclosed method in flow chart 700 with reference to FIG. 7, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more com-puter-readable media (e.g., non-transitory computer-readable media) and is considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or com-puter to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more nonvolatile memory devices, and/or a combination of one or more volatile memory devices and nonvolatile memory devices. In some embodiments, the computer programs may be provided to a computer using any type of transitory computer-readable media. Examples of transitory computer-readable media include electric signals, optical signals, and electromagnetic waves. Transitory com-puter readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configura-tions that are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer-implemented method, comprising:
accessing, by a server system, historical transaction data of payment transactions associated with an acquirer server from a transaction database;
determining, by the server system, acquirer features associated with the acquirer server and transaction features associated with an individual payment transaction based, at least in part, on the historical transaction data;
generating, by the server system via an embedding layer, a latent representation corresponding to the individual payment transaction based, at least in part, on the acquirer features and the transaction features; and
training, by the server system, a fraud classifier and an acquirer classifier based, at least in part, on the latent representation and a multi-component event-aware loss function, wherein the training is performed by executing a plurality of operations, the plurality of operations comprising:
computing, by the server system, the multi-component event-aware loss function based, at least in part, on execution of the fraud classifier and the acquirer classifier; and
updating, by the server system, network parameters of the fraud classifier, the acquirer classifier, and the embedding layer based, at least in part, on the multi-component event-aware loss function.

2. The computer-implemented method as claimed in claim 1, wherein the multi-component event-aware loss function is a combination of a recency-based cross-entropy loss component, an acquirer classification loss component, a predicted event rate (PER) optimization loss component, and a net benefit loss component.

3. The computer-implemented method as claimed in claim 2, wherein the recency-based cross-entropy loss component assigns a first weightage to recent payment transactions and a second weightage to older payment transactions, wherein the first weightage is greater than the second weightage.

4. The computer-implemented method as claimed in claim 2, wherein the acquirer classification loss component represents a value calculated based, at least in part, on the acquirer features associated with the acquirer server.

5. The computer-implemented method as claimed in claim 2, wherein the PER optimization loss component is defined as a ratio of a count of fraudulent payment transaction predictions to a total count of predictions.

6. The computer-implemented method as claimed in claim 1, wherein the fraud classifier, the acquirer classifier, and the embedding layer are comprised in a transaction monitoring model.

7. The computer-implemented method as claimed in claim 1, wherein the historical transaction data comprises information of both fraudulent and non-fraudulent payment transactions performed at the acquirer server.

8. The computer-implemented method as claimed in claim 1, wherein the fraud classifier is configured to classify whether the individual payment transaction is fraudulent.

9. The computer-implemented method as claimed in claim 1, wherein the server system is a payment server.

10. A server system comprising:
at least one processor; and
a memory storing computer-executable instructions thereon, which when executed by the at least one processer, cause the at least one processor to perform the operations of:
accessing historical transaction data of payment transactions associated with an acquirer server from a transaction database,
determining acquirer features associated with the acquirer server and transaction features associated with an individual payment transaction based, at least in part, on the historical transaction data,
generating, via an embedding layer, a latent representation corresponding to the individual payment transaction based, at least in part, on the acquirer features and the transaction features, and
training a fraud classifier and an acquirer classifier based, at least in part, on the latent representation and a multi-component event-aware loss function, wherein the training is performed by executing a plurality of steps, the plurality of steps comprising:
computing, by the server system, the multi-component event-aware loss function based, at least in part, on execution of the fraud classifier and the acquirer classifier, and
updating, by the server system, network parameters of the fraud classifier, the acquirer classifier, and the embedding layer based, at least in part, on the multi-component event-aware loss function.

11. The computer-implemented method as claimed in claim 10, wherein the multi-component event-aware loss function is a combination of a recency-based cross-entropy loss component, an acquirer classification loss component, a predicted event rate (PER) optimization loss component, and a net benefit loss component.

12. The computer-implemented method as claimed in claim 11, wherein the recency-based cross-entropy loss component assigns a first weightage to recent payment transactions and a second weightage to older payment transactions, wherein the first weightage is greater than the second weightage.

13. The computer-implemented method as claimed in claim 11, wherein the acquirer classification loss component represents a value calculated based, at least in part, on the acquirer features associated with the acquirer server.

14. The computer-implemented method as claimed in claim 11, wherein the PER optimization loss component is defined as a ratio of a count of fraudulent payment transaction predictions to a total count of predictions.

15. The computer-implemented method as claimed in claim 10, wherein the fraud classifier, the acquirer classifier, and the embedding layer are comprised in a transaction monitoring model.

16. The computer-implemented method as claimed in claim 10, wherein the historical transaction data comprises information of both fraudulent and non-fraudulent payment transactions performed at the acquirer server.

17. The computer-implemented method as claimed in claim 10, wherein the fraud classifier is configured to classify whether the individual payment transaction is fraudulent.

18. The computer-implemented method as claimed in claim 10, wherein the server system is a payment server.
